(19) United States
(12) Patent Application Publication
(10) Pub. No.: US 2022/0100065 A1
(43) Pub. Date: Mar. 31, 2022

(54) OPTOMECHANICAL MODULE AND PROJECTOR

(71) Applicant: Coretronic Corporation, Hsin-Chu (TW)

(72) Inventors: Kuang-Hsiang Chang, Hsin-Chu (TW); Wen-Hao Chu, Hsin-Chu (TW); Li-Wei Tseng, Hsin-Chu (TW)

(73) Assignee: Coretronic Corporation, Hsin-Chu (TW)

(21) Appl. No.: 17/477,555

(22) Filed: Sep. 17, 2021

(30) Foreign Application Priority Data
Sep. 25, 2020 (CN) 202011021869.6

(51) Int. Cl. G03B 21/16; G03B 21/20; G03B 21/14

(52) U.S. Cl. CPC G03B 21/16; G03B 21/145; G03B 21/2033

(57) ABSTRACT

An optomechanical module, including an optomechanical housing, a light source, and a display element, is provided. The optomechanical housing includes at least one heat-dissipation hole. The light source is configured to emit an illumination beam and is disposed in the optomechanical housing. The display element is disposed in the optomechanical housing, is located on a transmission path of the illumination beam, and is configured to convert the illumination beam into an image beam. When the optomechanical module operates, the light source generates heat, and the at least one heat-dissipation hole is configured to allow airflow to pass through, so as to dissipate the heat generated by the light source. A projector is also provided.

### CROSS-REFERENCE TO RELATED APPLICATION

This application claims the priority benefit of China application serial no. 202011021869.6, filed on Sep. 25, 2020. The entirety of the above-mentioned patent application is hereby incorporated by reference herein and made a part of this specification.

### BACKGROUND

### Technical Field

The disclosure relates to an optomechanical module and a projector, and particularly relates to an optomechanical module and a projector having a good heat dissipation effect.

### Description of Related Art

At present, with the increasing complexity of the application environment, the projector has gradually evolved from the open design in the past to a confined dust-proof design. It is not only necessary to prevent dust and moisture from entering the optomechanical module of the projector, but also to prevent dazzling light ray from being exposed to the outside of optomechanical module of the projector, thus resulting in the heat dissipation issue of such optomechanical module, which not only tortures and harms the optical elements disposed inside the optomechanical module, but also often causes the aging and damage of the internal optical lens element. The brightness may be attenuated, and in severe cases, there is a risk of melting due to high temperature.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an optomechanical module, which has a good heat dissipation effect.

The disclosure provides a projector, which has the optomechanical module.

An optomechanical module of the disclosure includes an optomechanical housing, a light source, and a display element. The optomechanical housing includes at least one heat-dissipation hole. The light source is configured to emit an illumination beam and is disposed in the optomechanical housing. The display element is disposed in the optomechanical housing, is located on the transmission path of the illumination beam, and is configured to convert the illumination beam into an image beam. When the optomechanical module operates, the light source generates heat, and the at least one heat-dissipation hole is configured to allow airflow to pass through, so as to dissipate the heat generated by the light source.

A projector of the disclosure includes an optomechanical module and a projection lens. The optomechanical module includes an optomechanical housing, a light source, and a display element. The optomechanical housing includes at least one heat-dissipation hole. The light source is configured to emit an illumination beam and is disposed in the optomechanical housing. The display element is disposed in the optomechanical housing, is located on the transmission path of the illumination beam, and is configured to convert the illumination beam into an image beam. When the optomechanical module operates, the light source generates heat, and the at least one heat-dissipation hole is configured to allow airflow to pass through, so as to dissipate the heat generated by the light source. The projection lens is connected to the optomechanical module and is configured to project the image beam outward.

Based on the above, the optomechanical housing of the optomechanical module of the disclosure includes the heat-dissipation hole. When the optomechanical module operates, the light source generates heat to increase the temperature in the optomechanical housing, and the heat-dissipation hole is configured to allow airflow to pass through, so as to dissipate the heat generated by the light source. Therefore, the optomechanical module of the disclosure may dissipate heat not only by the material of the optomechanical housing itself, but also by air convection. In addition, the heat-dissipation hole is disposed with a filter structure to prevent dust from entering the optomechanical module.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projector according to an embodiment of the disclosure.

FIG. 2A is a three-dimensional schematic diagram of an optomechanical module of the projector of FIG. 1.

FIG. 2B is a schematic diagram of FIG. 2A from another perspective.

FIG. 3 is a cross-sectional schematic diagram of the optomechanical module of FIG. 2A.

FIG. 4 is a three-dimensional schematic diagram of a filter structure of the optomechanical module of FIG. 2A separated from an optomechanical housing.

FIG. 5 is an exploded schematic diagram of the filter structure of the optomechanical module of FIG. 2A.

FIG. 6 is a three-dimensional cross-sectional schematic diagram of a portion of FIG. 2A.

FIG. 7 is a schematic diagram of the optomechanical module of FIG. 2A connected to an external fan.

FIG. 8 is a schematic diagram of an optomechanical module according to another embodiment of the disclosure.

FIG. 9 is a three-dimensional schematic diagram of a filter structure of the optomechanical module of FIG. 8 separated from an optomechanical housing.

FIG. 10 is a schematic diagram of the filter structure of the optomechanical module of FIG. 8.

FIG. 11 is a three-dimensional cross-sectional schematic diagram of a portion of FIG. 8.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

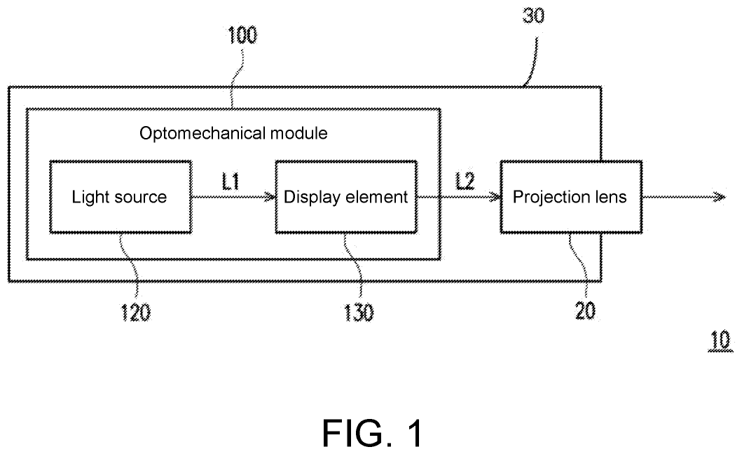

FIG. 1 is a schematic diagram of a projector according to an embodiment of the disclosure. Please refer to FIG. 1. A projector 10 of the embodiment includes an optomechanical module 100, a projection lens 20, and a projector housing 30. The optomechanical module 100 includes a light source 120 and a display element 130. The optomechanical module 100 is disposed in the projector housing 30.

The light source 120 is configured to emit an illumination beam L1 and is disposed in the optomechanical module 100. In the embodiment, the light source 120 is, for example, an excitation light source 120, but in other embodiments, the light source 120 may also be a light emitting diode or other light sources. The light emitted by the light source 120 is, for example, blue light, which may also be light beams of other colors, and is not limited thereto. For example, the light source 120 may include multiple laser elements (not shown). The laser elements are, for example, arranged in an array. The laser elements are, for example, laser diodes (LDs). In other embodiments, there may be multiple light sources 120. In other embodiments, the light source 120 may be a solid-state illumination source such as a light emitting diode. Or the light source 120 may include the laser diode and the light emitting diode.

The display element 130 is, for example, a light valve, is disposed on the transmission path of the illumination beam L1, and is configured to convert the illumination beam L1 into an image beam L2. In the embodiment, the light valve is, for example, a reflective light modulator such as a digital micro-mirror device (DMD) or a liquid crystal on silicon panel (LCoS panel). In some embodiments, the light valve may be, for example, a transmissive light modulator such as a liquid crystal display panel, an electro-optical modulator, a magneto-optical modulator, or an acousto-optical modulator (AOM), but it is not limited thereto. Of course, the display element 130 may also be other optical imaging elements, and is not limited thereto.

The projection lens 20 is connected to the optomechanical module 100, is disposed on the transmission path of the image beam L2 outputted from the optomechanical module 100, and is configured to project the image beam L2 out of the projector 10, so as to display an image on a screen, a wall, or other projection targets. In the embodiment, the projection lens 20 is disposed on the projector housing 30 to project the image beam L2 out of the projector housing 30. In the embodiment, the projection lens 20 includes, for example, a combination of one or more non-planar optical lens elements having refractive power, such as various combinations of non-planar lens elements including a biconcave lens, a biconvex lens, a concave-convex lens, a convex-concave lens, a plano-convex lens, and a plano-concave lens. In an embodiment, the projection lens 20 may also include a planar optical lens to project the image beam L2 from the display element 130 out of the projector 10 in a reflective or transmissive manner.

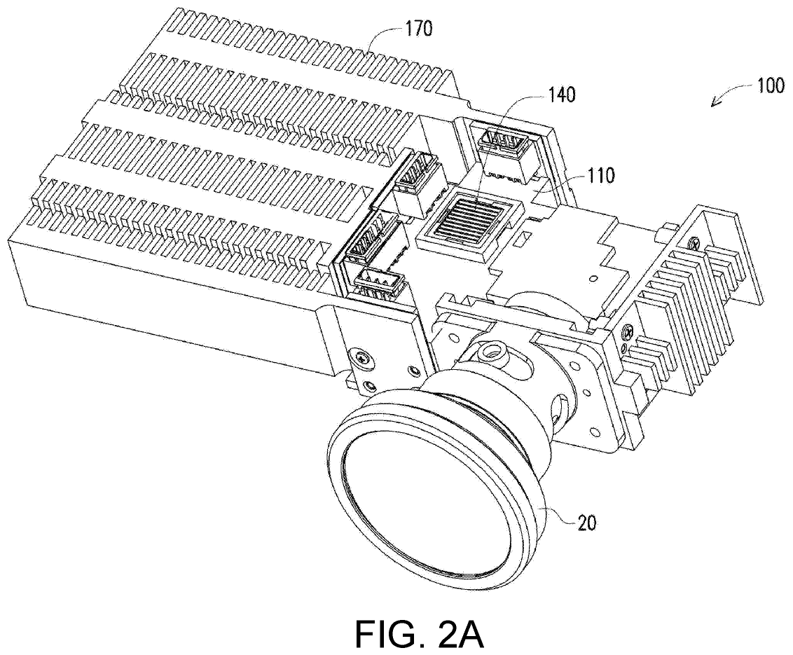

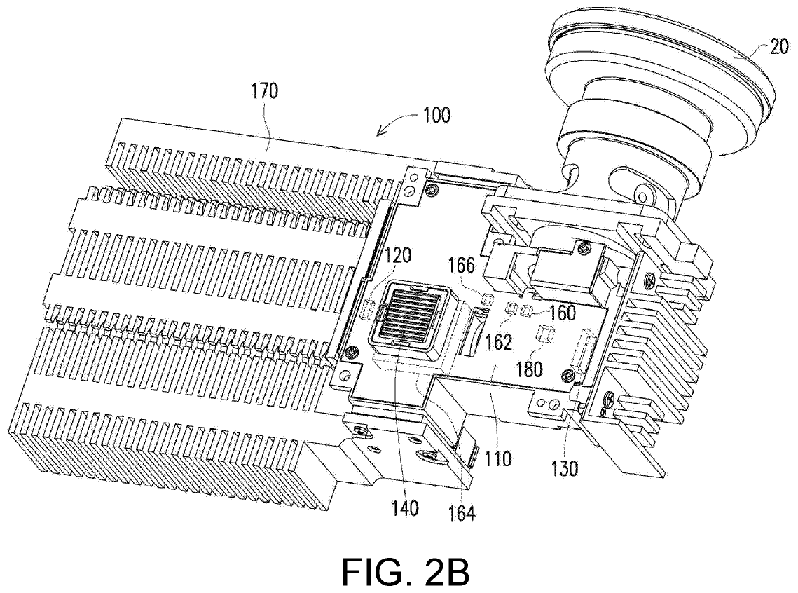

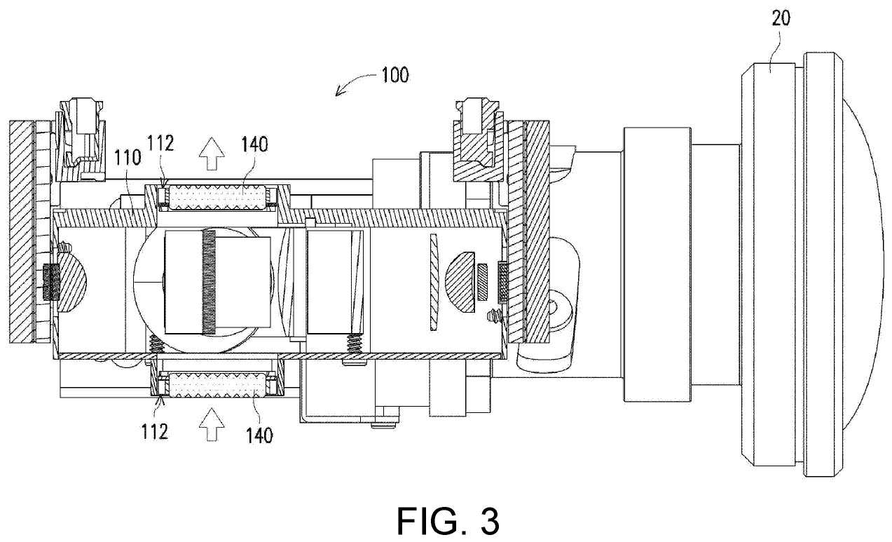

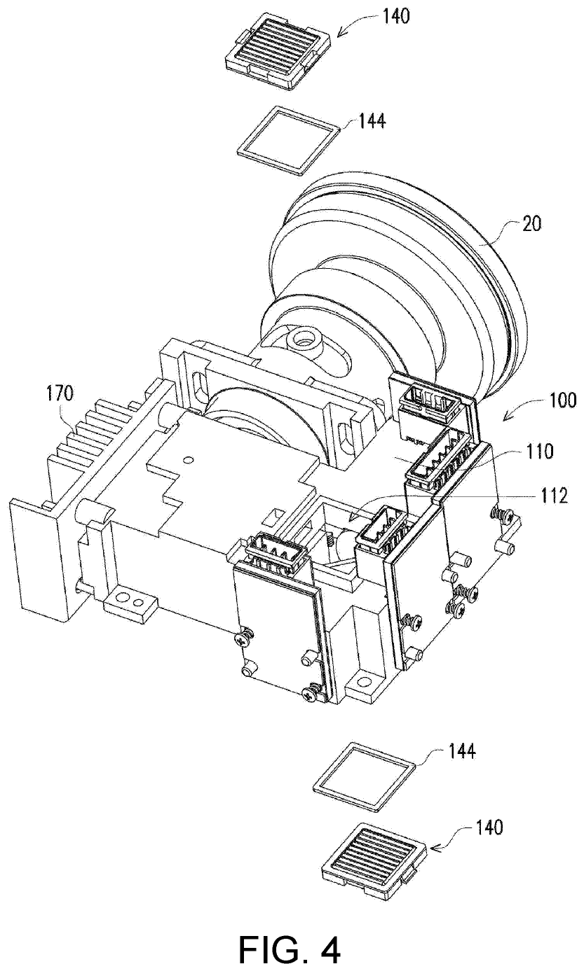

FIG. 2A is a three-dimensional schematic diagram of an optomechanical module of the projector of FIG. 1. FIG. 2B is a schematic diagram of FIG. 2A from another perspective. FIG. 3 is a cross-sectional schematic diagram of the optomechanical module of FIG. 2A. FIG. 4 is a three-dimensional schematic diagram of a filter structure of the optomechanical module of FIG. 2A separated from an optomechanical housing.

Please refer to FIG. 2A to FIG. 4. In the embodiment, the optomechanical module 100 includes an optomechanical housing 110. The light source 120 (FIG. 2B) and the display element 130 (FIG. 2B) are disposed in the optomechanical housing 110. The optomechanical housing 110 has a special design to help dissipate heat. Specifically, the optomechanical housing 110 is a dust-tight housing and includes at least one heat-dissipation hole 112. When the optomechanical module 100 operates, the light source 120 generates heat, and the at least one heat-dissipation hole 112 of the optomechanical housing 110 is configured to allow airflow to pass therethrough, so as to dissipate the heat generated by the light source 120 and the heat accumulated by the display element 130, so that the temperature in the optomechanical housing 110 decreases. In addition, the optomechanical module 100 further includes a heat-generating element 180, which is, for example, an element such as a circuit board. The heat-generating element 180 is disposed in the optomechanical housing 110. The heat-generating element 180 also generates heat during the operation of the optomechanical module 100. The airflow entering the optomechanical housing 110 from the heat-dissipation hole 112 may dissipate the heat generated by the light source 120 and the heat-generating element 180.

In the embodiment, since the temperature of the light source 120 is the highest, a position of the heat-dissipation hole 112 of the optomechanical housing 110 is, for example, provided close to the light source 120. As shown in FIG. 3, in the embodiment, the number of heat-dissipation holes 112 is, for example, two, and the positions of the two heat-dissipation holes 112 on the optomechanical housing 110 correspond to each other. For example, the two heat-dissipation holes 112 are provided on two opposite surfaces of the optomechanical housing 110. As shown in FIG. 3, one of the two heat-dissipation holes 112 is disposed at a top surface of the he optomechanical housing 110, and the other one of the two heat-dissipation holes 112 is disposed at a bottom surface of the he optomechanical housing 110. However, in other embodiments, the number of the heat-dissipation holes 112 may also be one or more, and the position of the heat-dissipation hole 112 is not limited thereto.

The optomechanical housing 110 may have at least two heat-dissipation holes 112. The heated air in the optomechanical housing 110 is allowed to automatically flow out of the optomechanical housing 110 through one of the heat-dissipation holes 112 due to the principle of gas expansion. While the heated air flows out, the fresh air enters the optomechanical housing 110 through the other one of the heat-dissipation holes 112 due to pressure difference. The air convection that automatically generated inside the optomechanical housing 110 due to temperature difference can accelerate the removal of heat energy in the optomechanical housing 110.

In addition, in the embodiment, in order to block external dust and prevent leakage of internal light ray, the optomechanical module 100 further includes at least one filter structure 140, which is detachably disposed in the at least one heat-dissipation hole 112. The filter structure 140 may be quickly assembled or replaced on the optomechanical housing 110. It is worth mentioning that in the embodiment, the filter structure 140 is made of an opaque material to prevent the light ray inside the optomechanical housing 110 from leaking to the outside. As shown in FIG. 3, two heat-dissipation holes 112 are respectively disposed with the filter structure 140, so that the dust is prevented from entering the optomechanical module 100 when the air convection is automatically generated inside the optomechanical housing 110.

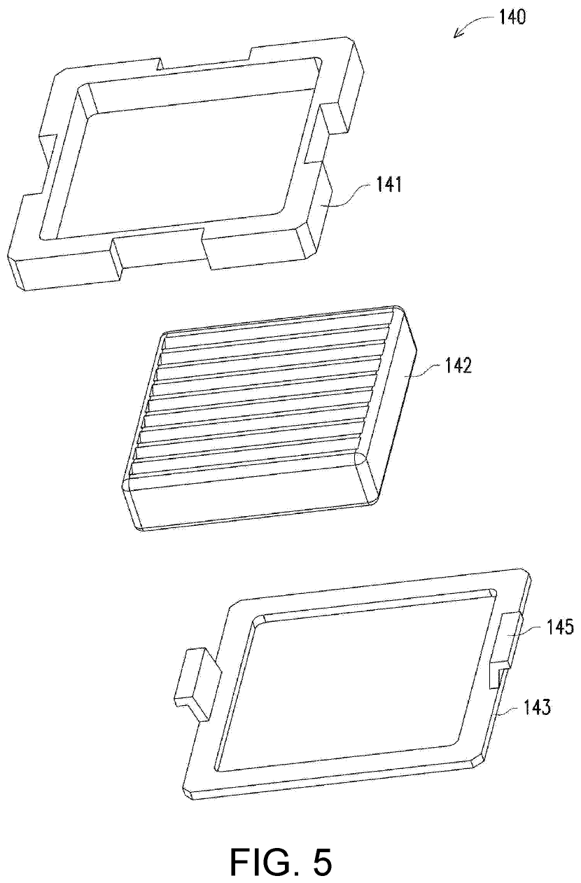

FIG. 5 is an exploded schematic diagram of the filter structure of the optomechanical module of FIG. 2A. Please refer to FIG. 5. In the embodiment, the filter structure 140 includes an upper frame 141, a filter 142, and a lower frame 143. The filter 142 is sandwiched between the upper frame 141 and the lower frame 143. In more detail, the upper frame 141 and the lower frame 143, for example, surround the edge of the filter 142 to fix the filter 142, but the disclosure is not limited thereto. The filter structure 140 may be formed using in-mold injection molding, or the filter 142, the upper frame 141, and the lower frame 143 may be welded together using a hot melt method to become a one-time (disposable) filter. Of course, in other embodiments, the upper frame 141, the filter 142, and the lower frame 143 may also be separate structures, and only the filter 142 may be replaced.

In the embodiment, the filter 142 may be made of a water-repellent material to reduce moisture damage caused by water vapor or water droplets seeping into the optomechanical housing 110. In addition, the filter 142 may have a corrugated structure to increase the allowable accumulation amount of dust and maintain the sustainability thereof. In the embodiment, the extension direction of the corrugated structure of the filter 142 is, for example, parallel to the surface of the optomechanical housing 110 corresponding to the heat-dissipation hole 112. The filter 142 may be a composite carbon cloth filter, a HEPA filter, an oil paper type or a sponge type air filter, but is not limited thereto.

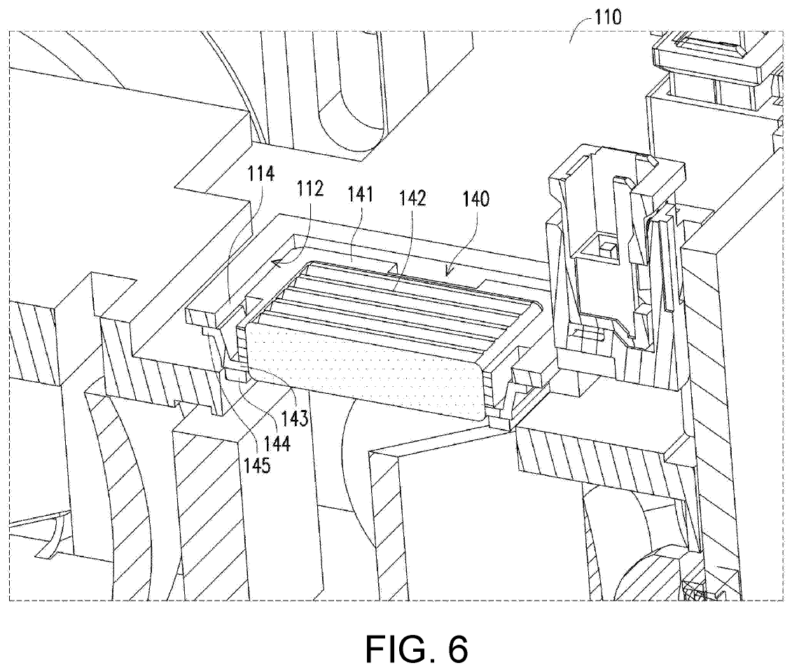

FIG. 6 is a three-dimensional cross-sectional schematic diagram of a portion of FIG. 2A. Please refer to FIG. 6. The optomechanical housing 110 includes at least one first engaging member 114 formed thereon. The filter structure 140 includes at least one second engaging member 145 corresponding to the first engaging member 114. In the embodiment shown in FIG. 5 and FIG. 6, the number of the first engaging member 114 and the number of the second engaging member 145 are two respectively. The two second engaging members 145 are located at the lower frame 143. The filter structure 140 is fixed to the optomechanical housing 110 through engaging the first engaging members 114 with the second engaging members 145 of the filter structure 140.

In addition, in the embodiment, a soft air-tight ring 144 is provided between the filter structure 140 and the optomechanical housing 110 to prevent leakage. The shape of the soft air-tight ring 144 is close to the appearance of the filter structure 140. The soft air-tight ring 144, for example, surrounds the lower frame 143 and abuts between the lower frame 143 and the optomechanical housing 110. The assembly pressure may be used to achieve the effect of all-around sealing, so as to achieve a compact effect, which can effectively prevent dust from entering the inside of the optomechanical housing 110 from surrounding uneven spaces and causing pollution. In addition, in the embodiment, the soft air-tight ring 144 may have the characteristic of high temperature resistance for long-term use in a high temperature environment.

Since the filter structure 140 gradually accumulates dirt and dust as the use time increases or as affected by the application environment, the dirt and dust on the filter structure 140 would affect the volume of air flowing through the heat dissipation holes of the optomechanical housing 110. Please return to FIG. 2B and FIG. 3. In the embodiment, the optomechanical module 100 further includes a temperature sensor 160, a controller 162, and an internal fan 164 disposed in the optomechanical housing 110. The temperature sensor 160 is disposed at a position in the optomechanical housing 110 and close to the light source 120 or the heat-generating element 180. The controller 162 is electrically connected to the temperature sensor 160. The internal fan 164 is disposed adjacent to the heat-dissipation hole 112 and is electrically connected to the controller 162.

When the temperature sensor 160 detects that the temperature of the light source 120 or the heat-generating element 180 has risen to a preset temperature threshold, it means that there is a risk of overheating in the optomechanical housing 110. At this time, the controller 162 may increase the rotational speed of the internal fan 164 to increase the volume of airflow, so as to help dissipate heat, or reduce the output power of the light source 120 to prevent damage to the important optical element in the optomechanical housing 110.

In addition, in the embodiment, the optomechanical module 100 further includes an alarm 166, which is electrically connected to the controller 162. The alarm 166 includes a warning device such as a buzzer, a horn, a display light, or a display screen, and may also be a combination of the foregoing warning devices. When the temperature sensor 160 detects that the temperature around the light source 120 or the heat-generating element 180 has risen to the preset temperature threshold, the controller 162 may also enable the alarm 166 to issue a warning to notify the user to update and clean the filter structure 140, so as to restore the original air volume.

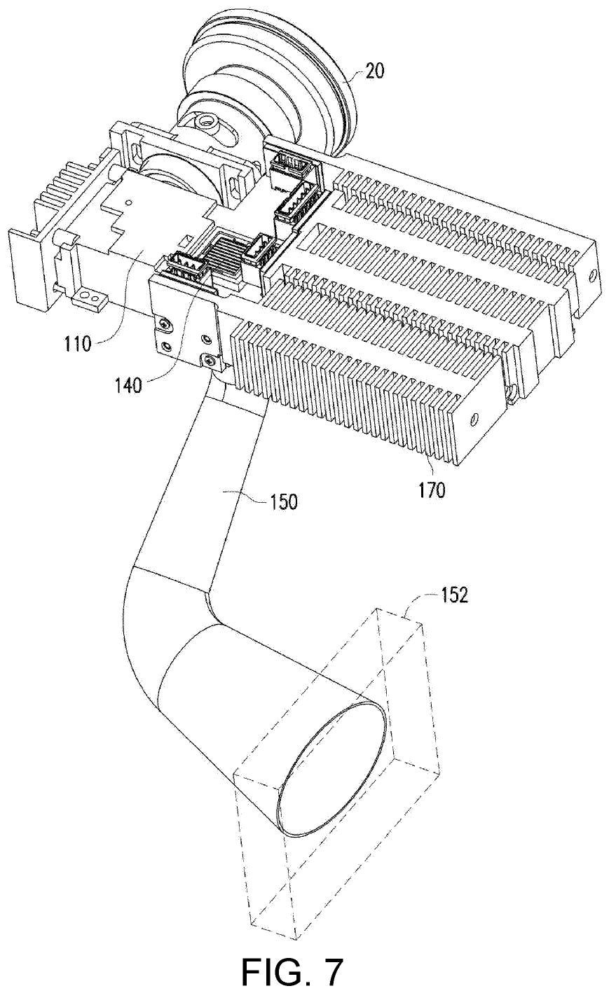

FIG. 7 is a schematic diagram of the optomechanical module of FIG. 2A connected to an external fan. Please refer to FIG. 7. In the embodiment, the optomechanical module 100 may optionally include an air duct 150, which is located outside the optomechanical housing 110 and has an open end (not labeled) disposed at one of the two heat-dissipation holes 112. Another open end (not labeled) of the air duct 150 is connected to an external fan 152 located outside the optomechanical housing 110. In the embodiment, in addition to natural air convection, the external fan 152 may also be used to pressurize the intake air to the optomechanical housing 110 as a means of forced cooling, so as to improve the heat discharge efficiency. In the embodiment, please refer to FIG. 1 and FIG. 7, the air duct 150 and the external fan 152 are, for example, disposed inside the projector housing 30, but the disclosure is not limited thereto.

Since the optomechanical module 100 itself has natural air convection, or has the characteristic of forced air convection in addition to natural air convection, a heat-dissipation fin 170 disposed on one side of the optomechanical module 100 is not the only heat dissipation structure. Therefore, compared with the heat-dissipation fins of other optomechanical modules, the volume and weight of the heat-dissipation fin 170 of the embodiment may be appropriately reduced, so that the overall volume may be reduced. Moreover, the heat-dissipation fin 170 may be disposed beside the optomechanical housing 110 or connected beside the housing 110 for dissipating the heat generated by the optomechanical module 100.

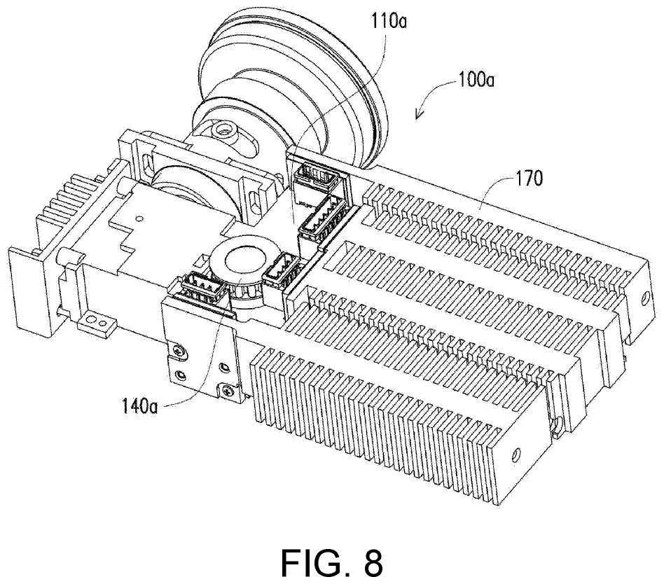

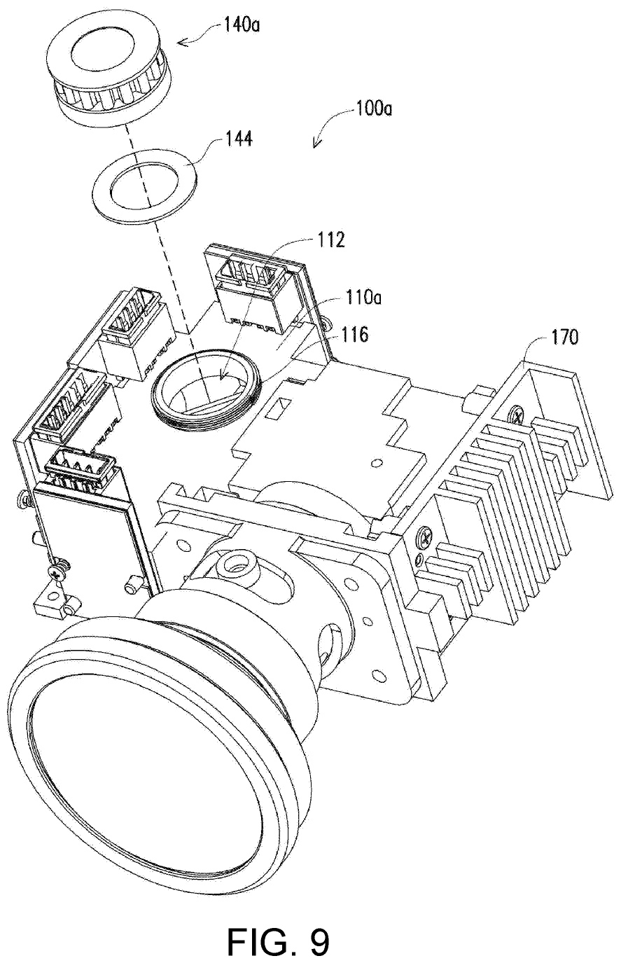

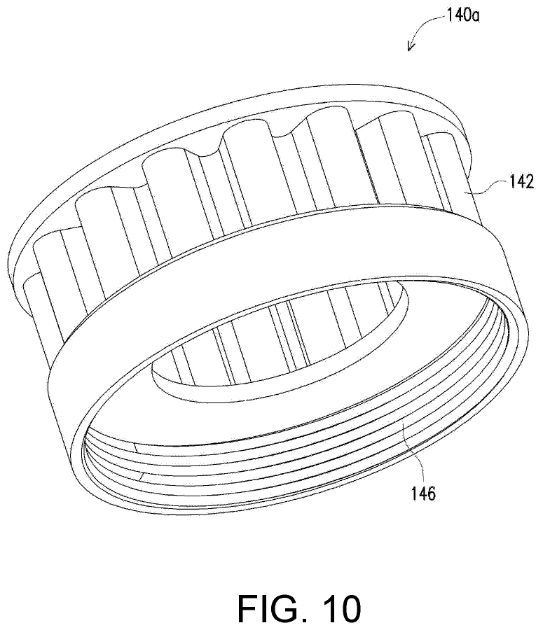

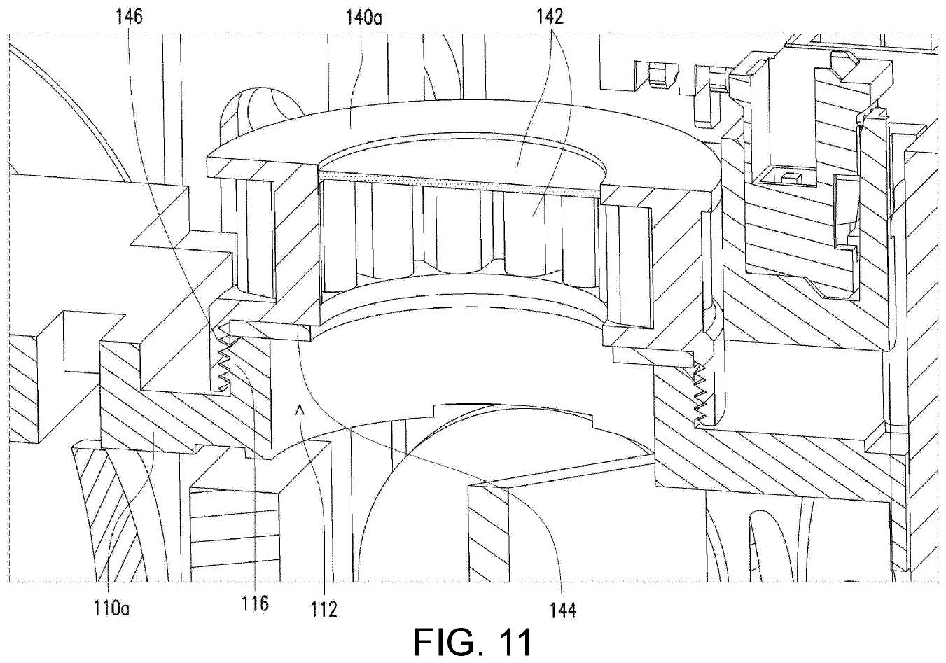

FIG. 8 is a schematic diagram of an optomechanical module according to another embodiment of the disclosure. FIG. 9 is a three-dimensional schematic diagram of a filter structure of the optomechanical module of FIG. 8 separated from an optomechanical housing. FIG. 10 is a schematic diagram of the filter structure of the optomechanical module of FIG. 8. FIG. 11 is a three-dimensional cross-sectional schematic diagram of a portion of FIG. 8.

Please refer to FIG. 8 to FIG. 11. In the embodiment, the way in which a filter structure 140a of an optomechanical module 100a is fixed to an optomechanical housing 110a is different from the foregoing embodiment. In the embodiment, the optomechanical housing 110a includes a first screw thread part 116, which is, for example, a thread structure is peripherally formed on the protruding portion extended from the edge of the heat-dissipation hole 112. The filter structure 140a includes a second screw thread part 146 corresponding to the first screw thread part 116. The filter structure 140a has, for example, a ring shape, and the second screw thread part 146 is, for example, a thread structure peripherally formed on the inner wall thereof. The filter structure 140a is screwed to the first screw thread part 116 through the second screw thread part 146 to be fixed to the optomechanical housing 110a. The first screw thread part 116 and the second screw thread part 146 respectively include a male thread and a female thread. The filter structure 140a and the optomechanical housing 110a are directly fixed by rotation, which does not require any special tool for disassembly and assembly. The filter structure 140a and the optomechanical housing 110a are also tightly sealed using a soft air-tight ring 144. In the embodiment, the extension direction of the corrugated structure of a filter 142 of the filter structure 140a is, for example, perpendicular to the surface of the optomechanical housing 110a corresponding to the heat-dissipation hole 112.

In summary, the optomechanical housing of the optomechanical module of the disclosure includes the heat-dissipation hole. When the optomechanical module operates, the light source and the heat-generating element generate heat, and the heat-dissipation hole is configured to allow airflow to pass through, so as to dissipate the heat generated by the light source and the heat-generating element. Therefore, the optomechanical module of the disclosure may dissipate heat not only by the material of the optomechanical housing itself, but also by air convection. In addition, the heat-dissipation hole is disposed with the filter structure, so that the air convection is generated inside the optomechanical housing and dust is prevented from entering the optomechanical module.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optomechanical module, comprising an optomechanical housing, a light source, and a display element, wherein:
the optomechanical housing comprises at least one heat-dissipation hole;
the light source is disposed in the optomechanical housing and is configured to emit an illumination beam; and
the display element is disposed in the optomechanical housing, is located on a transmission path of the illumination beam, and is configured to convert the illumination beam into an image beam, wherein when the optomechanical module operates, the light source generates heat, and the at least one heat-dissipation hole is configured to allow airflow to pass through, so as to dissipate the heat generated by the light source.

2. The optomechanical module according to claim 1, further comprising:
at least one filter structure, detachably disposed in the at least one heat-dissipation hole.

3. The optomechanical module according to claim 2, wherein the optomechanical housing comprises at least one first engaging member, the at least one filter structure comprises at least one second engaging member corresponding to the at least one first engaging member, and the at least one filter structure is fixed to the optomechanical housing through engaging the at least one first engaging member with the at least one second engaging member.

4. The optomechanical module according to claim 2, wherein the optomechanical housing comprises at least one first screw thread part, the at least one filter structure comprises at least one second screw thread part corresponding to the at least one first screw thread part, and the at least one filter structure is screwed to the at least one first screw thread part through the at least one second screw thread part to be fixed to the optomechanical housing.

5. The optomechanical module according to claim 1, further comprising:
an air duct located outside the optomechanical housing, wherein a number of the at least one heat-dissipation hole is two, the air duct is disposed at one of the two heat-dissipation holes and is configured to connect to a first external fan.

6. The optomechanical module according to claim 1, further comprising a temperature sensor, a controller, and an internal fan, wherein:
the temperature sensor is disposed in the optomechanical housing and is close to the display element;
the controller is electrically connected to the temperature sensor; and
the internal fan is electrically connected to the controller and is disposed adjacent to the at least one heat-dissipation hole.

7. The optomechanical module according to claim 6, further comprising:
an alarm, electrically connected to the controller, wherein the alarm comprises a buzzer, a horn, a display light, or a display screen.

8. A projector, comprising an optomechanical module and a projection lens, wherein:
the optomechanical module comprises an optomechanical housing, a light source, and a display element, wherein:
the optomechanical housing comprises at least one heat-dissipation hole;
the light source is configured to emit an illumination beam and is disposed in the optomechanical housing; and
the display element is disposed in the optomechanical housing, is located on a transmission path of the illumination beam, and is configured to convert the illumination beam into an image beam, wherein when the optomechanical module operates, the light source generates heat, and the at least one heat-dissipation hole is configured to allow airflow to pass through, so as to dissipate the heat generated by the light source; and
the projection lens is connected to the optomechanical module and is configured to project the image beam outward.

9. The projector of claim 8, wherein the optomechanical module further comprises:
at least one filter structure, detachably disposed in the at least one heat-dissipation hole.

10. The projector according to claim 9, wherein the optomechanical housing comprises at least one first engaging member, the at least one filter structure comprises at least one second engaging member corresponding to the at least one first engaging member, and the at least one filter structure is fixed to the optomechanical housing through engaging the at least one first engaging member with the at least one second engaging member.

11. The projector according to claim 9, wherein the optomechanical housing comprises at least one first screw thread part, the at least one filter structure comprises at least one second screw thread part corresponding to the at least one first screw thread part, and the at least one filter structure is screwed to the at least one first screw thread part through the at least one second screw p thread art to be fixed to the optomechanical housing.

12. The projector according to claim 8, wherein the optomechanical module further comprises:
an air duct located outside the optomechanical housing, wherein a number of the at least one heat-dissipation hole is two, the air duct is disposed at one of the two heat-dissipation holes and is configured to connect to an external fan.

13. The projector of claim 8, wherein the optomechanical module further comprises a temperature sensor, a controller, and an internal fan, wherein:
the temperature sensor is disposed in the optomechanical housing and is close to the display element;
the controller is electrically connected to the temperature sensor; and
the internal fan is electrically connected to the controller and is disposed adjacent to the at least one heat-dissipation hole.

14. The projector of claim 13, wherein the optomechanical module further comprises:
an alarm, electrically connected to the controller, wherein the alarm comprises a buzzer, a horn, a display light, or a display screen.
